(19) United States
(12) Patent Application Publication
(10) Pub. No.: US 2024/0208460 A1
(43) Pub. Date: Jun. 27, 2024

(54) VEHICLE CONTROLLER, VEHICLE CONTROL METHOD, AND RECORDING MEDIUM

(71) Applicant: HONDA MOTOR CO., LTD., Tokyo (JP)

(72) Inventors: Hiroki Yoshikawa, Tokyo (JP); Naoto Yamamoto, Tokyo (JP); Takayuki Inomata, Tokyo (JP)

(21) Appl. No.: 18/539,724

(22) Filed: Dec. 14, 2023

(30) Foreign Application Priority Data
Dec. 26, 2022 (JP) 2022-208281

(51) Int. Cl. B60R 25/021; B60R 25/20; B60R 25/22

(52) U.S. Cl. CPC B60R 25/021; B60R 25/209; B60R 25/22

(57) ABSTRACT

A vehicle controller includes: a remote operation reception unit which receives a remote operation of a vehicle; a steering lock recognition unit which recognizes a steering lock state where a steering is locked by a steering lock mechanism; a travel start operation recognition unit which recognizes an operation for starting travel of the vehicle; and a control unit which starts a drive source of the vehicle and turns the vehicle to a predetermined standby mode when an activation instruction for the vehicle is received by the remote operation reception unit in a state where the steering lock state is recognized, and stops the drive source when the operation for starting the travel of the vehicle in the vehicle is recognized by the travel start operation recognition unit in the standby mode.

### INCORPORATION BY REFERENCE

The present application claims priority under 35 U.S.C.§ 119 to Japanese Patent Application No. 2022-208281 filed on Dec. 26, 2022. The content of the application is incorporated herein by reference in its entirety.

### BACKGROUND OF THE INVENTION

### Field of the Invention

The present invention relates to a vehicle controller, a vehicle control method, and a recording medium.

### Description of the Related Art

Conventionally, a configuration in which a vehicle includes a steering lock mechanism for theft prevention and the steering lock mechanism is turned to a canceled (unlocked) state when the vehicle is being driven has been proposed (for example, see Japanese Patent Laid-Open No. 2003-063354). In addition, a configuration of fixing a shift position at a parking position when it is determined that a steering is not unlocked when an engine of the vehicle is started has been proposed (for example, see Japanese Patent Laid-Open No. 2005-299468).

In recent years, a function of starting a vehicle by a remote operation by a communication terminal or the like and enabling an actuation instruction for an air conditioner of the vehicle or the like has become popular. In the case of enabling start of the vehicle by the remote operation in such a manner, it is effective to activate the vehicle in a state of locking a steering by a steering lock mechanism from a viewpoint of preventing a theft of the vehicle. However, it is needed to avoid the start of use of the vehicle by a user in the state where the steering is locked.

Therefore, a problem of the present application is to avoid use of a vehicle in the state where a steering is locked, by a user who has gotten into the vehicle, when the vehicle is activated by a remote operation in the state where the steering is locked.

It is an object of the present application to improve safety in order to solve the problem. Then, the safety of traffic is further improved consequently to contribute to development of a sustainable transportation system.

### SUMMARY OF THE INVENTION

A first aspect for achieving the object described above is a vehicle controller loaded on a vehicle including a steering lock mechanism, and the vehicle controller includes: a remote operation reception unit configured to receive a remote operation of the vehicle by communication with a communication terminal; a steering lock recognition unit configured to recognize a steering lock state where a steering of the vehicle is locked by the steering lock mechanism; a travel start operation recognition unit configured to recognize an operation for starting travel of the vehicle in the vehicle; and a control unit configured to start a drive source of the vehicle and turn the vehicle to a predetermined standby mode when an activation instruction for the vehicle by the communication terminal is received by the remote operation reception unit in a state where the steering lock state is recognized by the steering lock recognition unit, and to stop the drive source when the operation for starting the travel of the vehicle in the vehicle is recognized by the travel start operation recognition unit in the standby mode.

The vehicle controller described above may be configured such that the travel start operation recognition unit recognizes an operation of a driving operation unit provided in the vehicle, as the operation for starting the travel of the vehicle in the vehicle.

The vehicle controller described above may be configured such that the travel start operation recognition unit recognizes an operation of a shift lever provided in the vehicle, as the operation of the driving operation unit.

The vehicle controller described above may be configured such that a user action prediction unit configured to predict an action of a user who has gotten in the vehicle is provided, and the travel start operation recognition unit recognizes the operation of the driving operation unit based on a prediction result of the action of the user by the user action prediction unit.

The vehicle controller described above may be configured such that the user action prediction unit predicts the action of the user based on one of a vehicle interior photographed image of the vehicle by a camera provided in the vehicle, a detection situation of a contact sensor provided in the driving operation unit, and an operation situation of a shift switch provided on a shift lever when the driving operation unit is the shift lever.

The vehicle controller described above may be configured such that the control unit cancels a lock of the steering by the steering lock mechanism when an automatic travel instruction for the vehicle by the communication terminal is received by the remote operation reception unit in the standby mode.

A second aspect for achieving the object described above is a control method of a vehicle including a steering lock mechanism executed by a computer, and the vehicle control method includes: a remote operation reception step of receiving a remote operation of the vehicle by communication with a communication terminal; a steering lock recognition step of recognizing a steering lock state where a steering of the vehicle is locked by the steering lock mechanism; a travel start operation recognition step of recognizing an operation for starting travel of the vehicle in the vehicle; and a control step of starting a drive source of the vehicle and turning the vehicle to a predetermined standby mode when an activation instruction for the vehicle by the communication terminal is received by the remote operation reception step in a state where the steering lock state is recognized by the steering lock recognition step, and stopping the drive source when the operation for starting the travel of the vehicle in the vehicle is recognized by the travel start operation recognition step in the standby mode.

A third aspect for achieving the object described above is a non-transitory computer readable recording medium on which a program for a computer loaded on a vehicle including a steering lock mechanism is recorded, the program causing the computer to function as: a remote operation reception unit configured to receive a remote operation of the vehicle by communication with a communication terminal; a steering lock recognition unit configured to recognize a steering lock state where a steering of the vehicle is locked by the steering lock mechanism; a travel start operation recognition unit configured to recognize an operation for starting travel of the vehicle in the vehicle; and a control unit configured to start a drive source of the vehicle and turn the vehicle to a predetermined standby mode when an activation instruction for the vehicle by the communication terminal is received by the remote operation reception unit in a state where the steering lock state is recognized by the steering lock recognition unit, and to stop the drive source when the operation for starting the travel of the vehicle in the vehicle is recognized by the travel start operation recognition unit in the standby mode.

According to the vehicle controller described above, when a vehicle is activated by a remote operation in a state where a steering is locked, use of the vehicle in the state where the steering is locked, by a user who has gotten into the vehicle, can be avoided.

### BRIEF DESCRIPTION OF THE DRAWINGS

FIG. 1 is a block diagram of a vehicle controller and a vehicle loaded with the vehicle controller;

FIG. 2 is a first flowchart of remote operation dealing processing; and

FIG. 3 is a second flowchart of the remote operation dealing processing.

### DETAILED DESCRIPTION OF THE PREFERRED EMBODIMENTS

### [1. Configuration of Vehicle Controller]

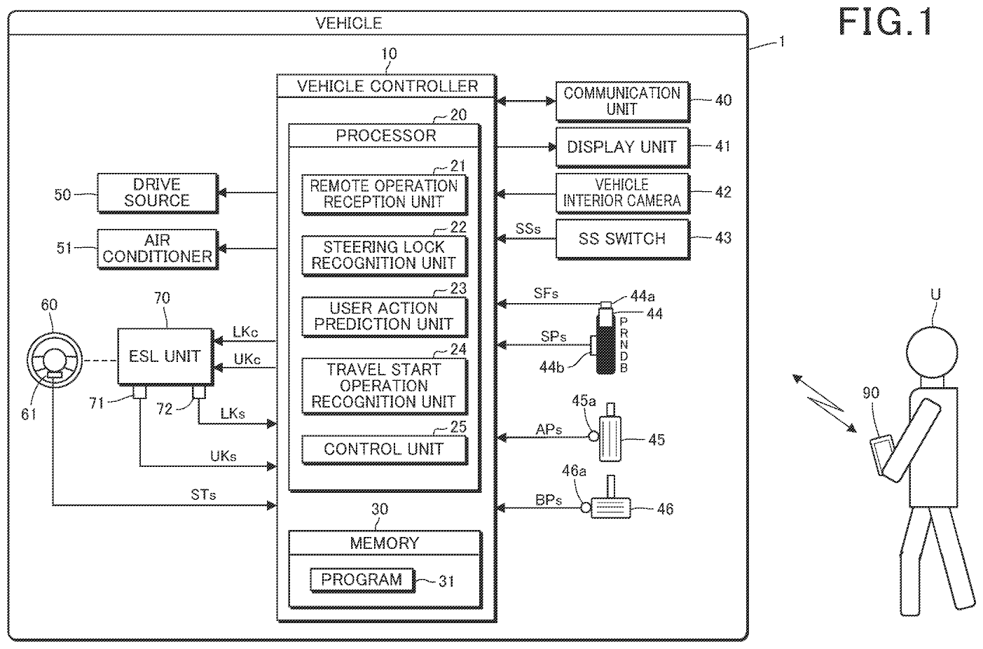

With reference to FIG. 1, the configuration of a vehicle controller 10 of the present embodiment will be explained. The vehicle controller 10 is connected with a communication unit 40, a display unit 41, a vehicle interior camera 42, an SS switch (start/stop switch) 43, a shift switch 44a, a shift position sensor 44b, an accelerator pedal sensor 45a, and a brake pedal sensor 46a, which are provided in a vehicle 1.

The display unit 41 is a touch panel for example. The vehicle interior camera 42 photographs the interior of the vehicle 1. The SS switch 43 is an operation switch for instructing activation (power ON) and stop (power OFF) of the vehicle 1. The shift switch 44a is an operation switch operated when a position of a shift lever 44 is changed from P (parking) or the like. The shift position sensor 44b detects which one of the P, R (reverse), N (neutral), D (drive) and B (brake) a shift position of the shift lever 44 is.

The accelerator pedal sensor 45a detects an operation amount of an accelerator pedal 45 provided in the vehicle 1. The brake pedal sensor 46a detects an operation amount of a brake pedal 46 provided in the vehicle 1. The vehicle controller 10 performs wireless communication with a communication terminal 90 carried by a user U by the communication unit 40. The wireless communication is executed by a communication standard of Bluetooth® for example.

The communication terminal 90 is a smartphone, a portable phone or a tablet terminal in which a remote operation application (application program) of the vehicle 1 is installed, or a portable key having a remote operation function or the like. By control signals outputted from the vehicle controller 10, a display screen of the display unit 41 is controlled.

To the vehicle controller 10, a photographed image by the vehicle interior camera 42, an operation signal SSs of the SS switch 43 and an operation signal SFs of the shift switch 44a are inputted. In addition, to the vehicle controller 10, a detection signal SPs of the shift position sensor 44b, a detection signal APs of the accelerator pedal sensor 45a, and a detection signal BPs of the brake pedal sensor 46a are inputted.

Further, the vehicle controller 10 is connected with a drive source 50, an air conditioner 51, a steering sensor 61, and an ESL (Electrical Steering Lock) unit 70. The drive source 50 is an engine when the vehicle 1 is an engine vehicle, and is a battery when the vehicle 1 is an electrically driven vehicle. In addition, when the vehicle 1 is a hybrid vehicle, the drive source 50 is an engine and a battery. The air conditioner 51 performs air conditioning of the interior of the vehicle 1.

The ESL unit 70 includes a steering lock mechanism which attains a steering lock state where an operation of a steering 60 is disabled by regulating turning of the steering 60 by an actuator such as an electric motor. Further, the ESL unit 70 includes a steering lock sensor 72 which detects that it is the steering lock state, and a steering unlock sensor 71 which detects that it is a steering unlock state where the lock of the steering is canceled and the operation of the steering 60 is enabled. The steering sensor 61 detects an operation amount of the steering 60.

The vehicle controller 10 is a control unit including a processor 20, a memory 30 and a non-illustrated interface circuit or the like. The processor 20 corresponds to a computer of the present disclosure. In the memory 30, a program 31 for control of the vehicle controller 10 is preserved. The program 31 may be transmitted from an external server to the vehicle 1 and preserved in the memory 30 by the vehicle controller 10. Alternatively, the program 31 preserved in a non-transitory recording medium (such as a magnetic disk, a magnetic tape, an optical disk and a flash memory) may be read by the vehicle controller 10 and preserved in the memory 30.

The processor 20 functions as a remote operation reception unit 21, a steering lock recognition unit 22, a user action prediction unit 23, a travel start operation recognition unit 24, and a control unit 25 by reading and executing the program 31. Processing executed by the remote operation reception unit 21 corresponds to a remote operation reception step in a vehicle control method of the present disclosure, and processing executed by the steering lock recognition unit 22 corresponds to a steering lock recognition step in the vehicle control method of the present disclosure. Processing executed by the travel start operation recognition unit 24 corresponds to a travel start operation recognition step in the vehicle control method of the present disclosure, and processing executed by the control unit 25 corresponds to a control step in the vehicle control method of the present disclosure.

The remote operation reception unit 21 receives a remote operation to the vehicle 1 by the user U by receiving operation instruction information to the vehicle 1 transmitted from the communication terminal 90 by the communication unit 40. The user U can instruct activation of the vehicle 1, actuation of the air conditioner 51 and automatic travel of the vehicle 1 or the like by the remote operation.

The steering lock recognition unit 22 recognizes the steering lock state based on a detection signal LKs of the steering lock sensor 72. The user action prediction unit 23 predicts the action of the user U based on the vehicle interior photographed image by the vehicle interior camera 42 and the operation signal SFs of the shift switch 44a.

That is, the user action prediction unit 23 predicts a behavior of trying to operate an operation unit (such as the shift lever 44, the accelerator pedal 45, the brake pedal 46 and the steering 60) by the user U by extracting an image portion of the user U who has gotten into the vehicle 1 from the photographed image of the vehicle interior camera 42. In addition, the user action prediction unit 23 predicts an operation of trying to change the shift lever 44 from a P position by the user U based on the operation signal SFs of the shift switch 44a.

The travel start operation recognition unit 24 recognizes the operation (travel start operation) of the operation unit (the shift lever 44, the accelerator pedal 45, the brake pedal 46 and the steering 60) for starting travel of the vehicle 1 by the user U, based on the detection signal SPs of the shift position sensor 44b, the detection signal APs of the accelerator pedal sensor 45a, the detection signal BPs of the brake pedal sensor 46a and a detection signal STs of the steering sensor 61, or a prediction situation of the action of the user U by the user action prediction unit 23.

The control unit 25 controls the actuation of the vehicle 1 based on the operation instruction information received by the remote operation reception unit 21. The control unit 25 starts the drive source 50 when an activation instruction is received by the remote operation reception unit 21. When the drive source 50 is an engine, the control unit 25 starts the engine.

The vehicle controller 10 executes remote operation dealing processing for avoiding start of the travel of the vehicle 1 in the steering lock state when the user U gets into the vehicle 1 in a situation where the drive source 50 is started by the remote operation and the drive source 50 is actuated.

### [2. Remote Operation Dealing Processing]

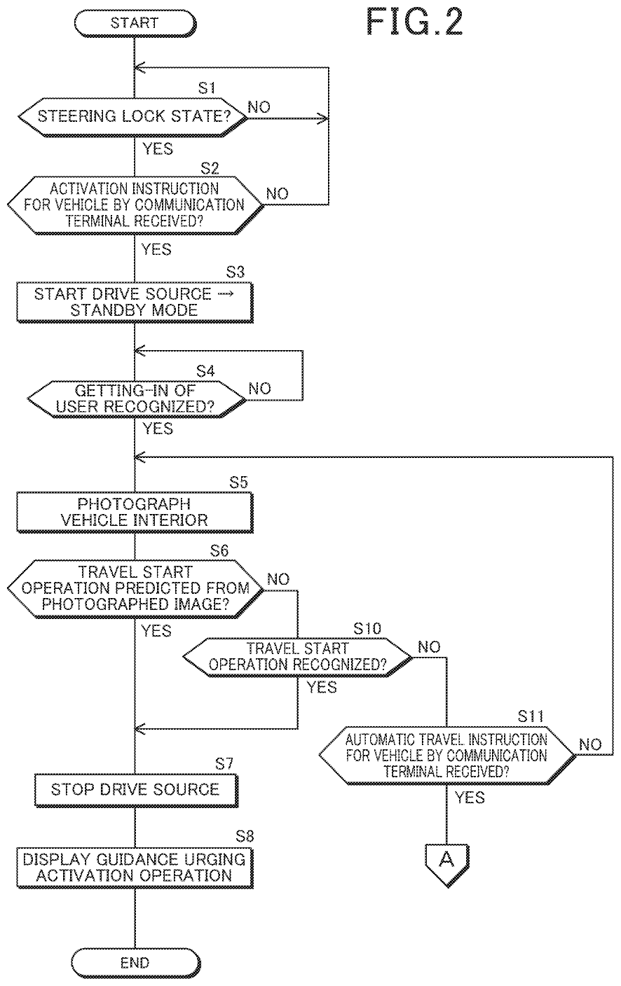

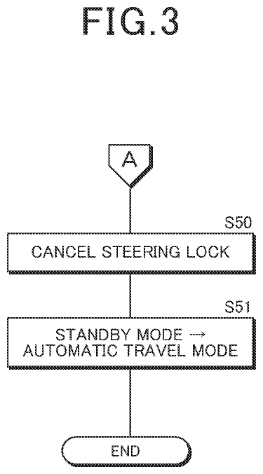

According to flowcharts illustrated in FIG. 2 and FIG. 3, the remote operation dealing processing executed by the vehicle controller 10 will be explained. When it is recognized that it is the steering lock state by the steering lock recognition unit 22 in step S1 in FIG. 2 and the activation instruction for the vehicle 1 is received by the remote operation reception unit 21 in step S2, the control unit 25 advances the processing to step S3.

In step S3, the drive source 50 is started (the engine is started when the drive source 50 is the engine), and a standby mode in which the drive source 50 is actuated is attained. In following step S4, the control unit 25 advances the processing to step S5 when it is recognized that the user U has gotten into the vehicle 1 by a door opening detection signal by a door sensor (not illustrated) provided in the vehicle 1 or the photographed image of the vehicle interior camera 42 or the like.

The user action prediction unit 23 photographs the vehicle interior by the vehicle interior camera 42 in step S5, and the user action prediction unit 23 predicts presence/absence of the travel start operation by the user U from the photographed image of the vehicle interior camera 42 and the operation signal SSs of the shift switch 44a in following step S6. The travel start operation recognition unit 24 advances the processing to step S7 when the travel start operation by the user U is predicted by the user action prediction unit 23, and advances the processing to step S10 when the travel start operation by the user U is not predicted by the user action prediction unit 23.

In step S10, the travel start operation recognition unit 24 determines whether or not the travel start operation by the user U is recognized from the detection signal SPs of the shift position sensor 44b, the detection signal APs of the accelerator pedal sensor 45a, the detection signal BPs of the brake pedal sensor 46a, and the detection signal STs of the steering sensor 61. Then, the travel start operation recognition unit 24 advances the processing to step S7 when the travel start operation by the user U is recognized, and advances the processing to step S11 when the travel start operation by the user U is not recognized. In step S11, the control unit 25 determines whether or not an automatic travel instruction for the vehicle 1 is received by the remote operation reception unit 21. Then, the control unit 25 advances the processing to step S50 in FIG. 3 when the automatic travel instruction for the vehicle 1 is received, and advances the processing to step S5 when the automatic travel instruction for the vehicle 1 is not received.

In step S7, the control unit 25 stops the drive source 50. Thus, the start of the travel of the vehicle 1 in the steering lock state is avoided. In following step S8, the control unit 25 displays a guidance screen urging an activation operation of the vehicle 1 by the operation of the SS switch 43 at the display unit 41. When the operation of the SS switch 43 is recognized, the control unit 25 starts the drive source 50, also cancels the lock of the steering 60 by the ESL unit 70, and enables the operation of the steering 60 by the user U.

In step S50 in FIG. 3, the control unit 25 cancels the lock of the steering 60 by the ESL unit 70. In following step S51, the control unit 25 switches the standby mode to an automatic travel mode, and executes the automatic travel of the vehicle 1 according to automatic travel instruction information by the remote operation. The automatic travel includes, for example, movement of the vehicle 1 from a position where the vehicle 1 is parked to a standby position of the user U, and the movement from a position where the vehicle 1 stands by to a parking lot.

### 3. Other Embodiments

In the embodiment described above, the shift lever 44, the accelerator pedal 45, the brake pedal 46 and the steering 60 are exemplified as the operation unit of the vehicle 1, however, the operation unit may be an operation which recognizes instruction voice of the user U or an operation unit which recognizes an instruction gesture by the user U or the like.

In the embodiment described above, the user action prediction unit 23 predicts the action of the user U based on the photographed image of the vehicle interior camera 42 and the operation signal SFs of the shift switch 44a. As another embodiment, the shift lever 44 and the steering 60 operated by the user U may be provided with a touch sensor and the user action prediction unit 23 may predict a driving start operation by the user U when a touch of the user U is detected by the touch sensor.

In the embodiment described above, the user action prediction unit 23 is provided and the travel start operation recognition unit 24 recognizes the travel start operation by the user U based on a prediction result by the user action prediction unit 23, however, the user action prediction unit 23 may be omitted.

Note that FIG. 1 is a schematic drawing in which the configuration of the vehicle controller 10 is divided according to main processing contents and illustrated in order to facilitate understanding of the invention of the present application, and the vehicle controller 10 may be configured by other divisions. In addition, the processing of each component may be executed by one hardware unit or may be executed by a plurality of hardware units. Further, the processing by each component illustrated in FIG. 2 and FIG. 3 may be executed by one program or may be executed by a plurality of programs.

### 4. Configurations Supported by Embodiment Described Above

The embodiment described above is a specific example of the following configurations.

(Configuration 1) A vehicle controller loaded on a vehicle including a steering lock mechanism, the vehicle controller including: a remote operation reception unit configured to receive a remote operation of the vehicle by communication with a communication terminal; a steering lock recognition unit configured to recognize a steering lock state where a steering of the vehicle is locked by the steering lock mechanism; a travel start operation recognition unit configured to recognize an operation for starting travel of the vehicle in the vehicle; and a control unit configured to start a drive source of the vehicle and turn the vehicle to a predetermined standby mode when an activation instruction for the vehicle by the communication terminal is received by the remote operation reception unit in a state where the steering lock state is recognized by the steering lock recognition unit, and to stop the drive source when the operation for starting the travel of the vehicle in the vehicle is recognized by the travel start operation recognition unit in the standby mode.

According to the vehicle controller of configuration 1, when the vehicle is activated in the state where the steering is locked by the steering lock mechanism, the use of the vehicle in the state where the steering is locked, by the user who has gotten into the vehicle, can be avoided.

(Configuration 2) The vehicle controller according to configuration 1, wherein the travel start operation recognition unit recognizes an operation of a driving operation unit provided in the vehicle, as the operation for starting the travel of the vehicle in the vehicle.

According to the vehicle controller of configuration 2, the operation of the driving operation unit provided in the vehicle can be recognized as the operation for starting the travel of the vehicle in the vehicle.

(Configuration 3) The vehicle controller according to configuration 2, wherein the travel start operation recognition unit recognizes an operation of a shift lever provided in the vehicle, as the operation of the driving operation unit.

According to the vehicle controller of configuration 3, the operation of the shift lever provided in the vehicle is recognized as the operation of the driving operation unit and the operation for starting the travel of the vehicle in the vehicle can be recognized.

(Configuration 4) The vehicle controller according to configuration 2 or configuration 3, including a user action prediction unit configured to predict an action of a user who has gotten in the vehicle, wherein the travel start operation recognition unit recognizes the operation of the driving operation unit based on a prediction result of the action of the user by the user action prediction unit.

According to the vehicle controller of configuration 4, by estimating the action of the user, the drive source is promptly stopped before the user actually operates the driving operation unit, and the use of the vehicle in the state where the steering is locked can be avoided.

(Configuration 5) The vehicle controller according to configuration 4, wherein the user action prediction unit predicts the action of the user based on one of a vehicle interior photographed image of the vehicle by a camera provided in the vehicle, a detection situation of a contact sensor provided in the driving operation unit, and an operation situation of a shift switch provided on a shift lever when the driving operation unit is the shift lever.

According to the vehicle controller of configuration 5, the action of the user can be estimated based on one of the vehicle interior photographed image by the camera provided in the vehicle, the detection situation of the contact sensor provided in the driving operation unit, and the operation situation of the shift switch provided on the shift lever.

(Configuration 6) The vehicle controller according to any one of configuration 1 to configuration 5, wherein the control unit cancels a lock of the steering by the steering lock mechanism when an automatic travel instruction for the vehicle by the communication terminal is received by the remote operation reception unit in the standby mode.

According to the vehicle controller of configuration 6, when an instruction to make the vehicle automatically travel independent of a steering operation by the user is received, the steering lock is canceled and the automatic travel of the vehicle can be made possible.

(Configuration 7) A control method of a vehicle including a steering lock mechanism executed by a computer, the vehicle control method including: a remote operation reception step of receiving a remote operation of the vehicle by communication with a communication terminal; a steering lock recognition step of recognizing a steering lock state where a steering of the vehicle is locked by the steering lock mechanism; a travel start operation recognition step of recognizing an operation for starting travel of the vehicle in the vehicle; and a control step of starting a drive source of the vehicle and turning the vehicle to a predetermined standby mode when an activation instruction for the vehicle by the communication terminal is received by the remote operation reception step in a state where the steering lock state is recognized by the steering lock recognition step, and stopping the drive source when the operation for starting the travel of the vehicle in the vehicle is recognized by the travel start operation recognition step in the standby mode.

By executing the vehicle control method of configuration 7 by the computer, effects similar to that of the vehicle controller of configuration 1 can be obtained.

(Configuration 8) A non-transitory computer readable recording medium on which a program for a computer loaded on a vehicle including a steering lock mechanism is recorded, the program causing the computer to function as: a remote operation reception unit configured to receive a remote operation of the vehicle by communication with a communication terminal; a steering lock recognition unit configured to recognize a steering lock state where a steering of the vehicle is locked by the steering lock mechanism; a travel start operation recognition unit configured to recognize an operation for starting travel of the vehicle in the vehicle; and a control unit configured to start a drive source of the vehicle and turn the vehicle to a predetermined standby mode when an activation instruction for the vehicle by the communication terminal is received by the remote operation reception unit in a state where the steering lock state is recognized by the steering lock recognition unit, and to stop the drive source when the operation for starting the travel of the vehicle in the vehicle is recognized by the travel start operation recognition unit in the standby mode.

By executing the program of configuration 8 by the computer loaded on the vehicle including the steering lock mechanism, the configuration of the vehicle controller of configuration 1 can be realized.

### REFERENCE SIGNS LIST

1 . . . vehicle, 10 . . . vehicle controller, 20 . . . processor, 21 . . . remote operation reception unit, 22 . . . steering lock recognition unit, 23 . . . user action prediction unit, 24 . . . travel start operation recognition unit, 25 . . . control unit, 30 . . . memory, 31 . . . program, 40 . . . communication unit, 41 . . . display unit, 42 . . . vehicle interior camera, 43 . . . SS switch, 44 . . . shift lever, 44a . . . shift switch, 44b . . . shift position sensor, 45 . . . accelerator pedal, 45a . . . accelerator pedal sensor, 46 . . . brake pedal, 46a . . . brake pedal sensor, 50 . . . drive source, 51 . . . air conditioner, 60 . . . steering, 61 . . . steering sensor, 70 . . . ESL unit, 71 . . . steering unlock sensor, 72 . . . steering lock sensor, 90 . . . communication terminal, U . . . user.

What is claimed is:

1. A vehicle controller loaded on a vehicle including a steering lock mechanism, the vehicle controller comprising:
a remote operation reception unit configured to receive a remote operation of the vehicle by communication with a communication terminal;
a steering lock recognition unit configured to recognize a steering lock state where a steering of the vehicle is locked by the steering lock mechanism;
a travel start operation recognition unit configured to recognize an operation for starting travel of the vehicle in the vehicle; and
a control unit configured to start a drive source of the vehicle and turn the vehicle to a predetermined standby mode when an activation instruction for the vehicle by the communication terminal is received by the remote operation reception unit in a state where the steering lock state is recognized by the steering lock recognition unit, and to stop the drive source when the operation for starting the travel of the vehicle in the vehicle is recognized by the travel start operation recognition unit in the standby mode.

2. The vehicle controller according to claim 1,
wherein the travel start operation recognition unit recognizes an operation of a driving operation unit provided in the vehicle, as the operation for starting the travel of the vehicle in the vehicle.

3. The vehicle controller according to claim 2,
wherein the travel start operation recognition unit recognizes an operation of a shift lever provided in the vehicle, as the operation of the driving operation unit.

4. The vehicle controller according to claim 2, comprising
a user action prediction unit configured to predict an action of a user who has gotten in the vehicle,
wherein the travel start operation recognition unit recognizes the operation of the driving operation unit based on a prediction result of the action of the user by the user action prediction unit.

5. The vehicle controller according to claim 4,
wherein the user action prediction unit predicts the action of the user based on one of a vehicle interior photographed image of the vehicle by a camera provided in the vehicle, a detection situation of a contact sensor provided in the driving operation unit, and an operation situation of a shift switch provided on a shift lever when the driving operation unit is the shift lever.

6. The vehicle controller according to claim 1,
wherein the control unit cancels a lock of the steering by the steering lock mechanism when an automatic travel instruction for the vehicle by the communication terminal is received by the remote operation reception unit in the standby mode.

7. A control method of a vehicle including a steering lock mechanism executed by a computer, the vehicle control method comprising:
a remote operation reception step of receiving a remote operation of the vehicle by communication with a communication terminal;
a steering lock recognition step of recognizing a steering lock state where a steering of the vehicle is locked by the steering lock mechanism;
a travel start operation recognition step of recognizing an operation for starting travel of the vehicle in the vehicle; and
a control step of starting a drive source of the vehicle and turning the vehicle to a predetermined standby mode when an activation instruction for the vehicle by the communication terminal is received by the remote operation reception step in a state where the steering lock state is recognized by the steering lock recognition step, and stopping the drive source when the operation for starting the travel of the vehicle in the vehicle is recognized by the travel start operation recognition step in the standby mode.

8. A non-transitory computer readable recording medium on which a program for a computer loaded on a vehicle including a steering lock mechanism is recorded, the program causing the computer to function as:
a remote operation reception unit configured to receive a remote operation of the vehicle by communication with a communication terminal;
a steering lock recognition unit configured to recognize a steering lock state where a steering of the vehicle is locked by the steering lock mechanism;
a travel start operation recognition unit configured to recognize an operation for starting travel of the vehicle in the vehicle; and
a control unit configured to start a drive source of the vehicle and turn the vehicle to a predetermined standby mode when an activation instruction for the vehicle by the communication terminal is received by the remote operation reception unit in a state where the steering lock state is recognized by the steering lock recognition unit, and to stop the drive source when the operation for starting the travel of the vehicle in the vehicle is recognized by the travel start operation recognition unit in the standby mode.
